(19) United States
(12) Patent Application Publication
(10) Pub. No.: US 2004/0222332 A1
(43) Pub. Date: Nov. 11, 2004

(54) Support device

(75) Inventors: Hans Regnell, Ytterby (SE); Ulf Johansson, Kungsbacka (SE)

Correspondence Address: TRACY W. DRUCE, ESQ., 1496 EVANS FARM DR, MCLEAN, VA, 22101, US

(73) Assignee: Volvo Lastvagnar AB, Goteborg (SE)

(21) Appl. No.: 10/710,105

(22) Filed: Jun. 18, 2004

Related U.S. Application Data
(63) Continuation of application No. PCT/SE02/02294, filed on Dec. 11, 2002.

(30) Foreign Application Priority Data
Dec. 18, 2001 (SE) 0104284-5

(51) Int. Cl. F16L 3/00

(52) U.S. Cl. 248/49

(57) ABSTRACT

Support device configured to fasten pipes, hoses and cabling to a vehicle. The support device has an essentially linear central axis, and a circumferential surface of the support device is at least partially circular and oriented around the central axis of the support device.

### CROSS-REFERENCE TO RELATED APPLICATIONS

The present application is a continuation patent application of International Application No. PCT/SE02/02294 filed Dec. 11, 2002 which was published in English pursuant to Article 21(2) of the Patent Cooperation Treaty, and which claims priority to Swedish Application No. 0104284-5 filed Dec. 18, 2001. Both applications are expressly incorporated herein by reference in their entireties.

### TECHNICAL FIELD

The present invention relates to a support device intended for use in fastening pipes, hoses and cabling to a vehicle.

### BACKGROUND ART

Various types of fitting support devices are available for fastening components, especially pipes, hoses and cables to the frame of a vehicle.

Components of this type are usually fastened to support devices which are fixed to the frame of the vehicle. On heavy vehicles, such as trucks or buses, some form of standard support device is used for all types of fastening. This support device includes a bent sheet-metal angle bracket that is fixed by a bolt in the frame and is provided with a number of notches through which a cable tie, for example, can be fitted in order to fasten the component in question.

These support devices have a number of disadvantages. A major problem is that they have sharp edges. When a component bears against the edge, the component sustains damage due to wear. This problem is greatest in the case of components that lie approximately at right angles to the support device.

Since the support device is a standard support device, it is not possible to find the optimum orientation of the support device; that is to say, the angle of the support device in relation to the component for each particular fitting. Furthermore, one and the same support device may need to be oriented at different angles depending on the vehicle type and equipment. This means that the components are often exposed to undesirable wear against the edges of the support device. Even if an angular position of the support device is predefined, this position is easily altered when the support device is tightened by means of a wrench, for example. The support device readily rotates with the bolt or the nut when it is tightened. A few degrees misalignment of the support device may be sufficient for wear against the edge to occur. It therefore becomes difficult to fit a support device with the correct orientation. The extent of the support device misalignment comes to depend on which fitter fitted it.

It is also possible for two or more components to be fitted to the same support device. These components may have different angular positions relative to one another and which means that at least one of the components will bear against the edge of the support device.

All of this contributes to unwanted wear damage between the support device and the component. Vibrations in the vehicle, which partly originate from the drivetrain and partly occur when the vehicle is being driven on poor roads, for example, aggravate the wear. This wear, for example, can wear holes in a hose or cause short-circuiting in a cable that can lead to operating faults or, even worse, to dangerous driving situations.

U.S. Pat. No. 5,632,457 describes an example of a similar support device.

One solution to the problem of orienting the support device might be to fasten the support device by means of two fasteners. The support device would then have a pre-defined orientation. The disadvantage to such a design is that it increases the size of the support device and each support device takes up two holes in the frame. Yet another problem is that even if the support device is oriented as required, undesirable wear can occur between the component and the edge of the support device. Moreover, it is more expensive and takes a longer time to fasten a support device using two fasteners.

Another way of solving the problem described above might be to use specially produced fasteners for each fitting position, but a modern truck may have up to a hundred support devices, and therefore such a solution becomes unduly expensive and complicated.

### DISCLOSURE OF INVENTION

An object of the invention is to provide a support device that increases the error tolerance in the orientation of the support device.

According to the invention, this object is achieved by the support device intended for use in fastening pipes, hoses and cabling to a vehicle. The support device has a circumferential surface that is convex and at least partially circular, the circumferential surface being oriented around the central axis of the support device.

A first embodiment of the support device configured according to the teachings of the invention means that vehicle-specific components, in particular pipes, hoses and cabling, can be fastened to the circumferential surface of the support device in various directions without the risk that the components will be exposed to wear against edge surfaces of the support device. The purpose is to prevent damage to the components so that vehicle operating faults are avoided. This also increases the tolerance in the orientation of the support device, which simplifies fitting of the support device.

In an advantageous first development of the support device configured according to the teachings of the invention includes a circumferential surface of the support device being circular. The aim of this characteristic is to provide a support device that is entirely independent of orientation, and in which components can be fitted in all directions.

In an advantageous second development of the support device according to the present invention, the support device is provided with notches. The aim of this characteristic is to facilitate the fitting of vehicle-specific components, which can exemplarily be done using cable ties.

In an advantageous third development of the support device configured according to the invention, the support device is provided with an edge section which is configured to improve fixation of the components.

### BRIEF DESCRIPTION OF THE DRAWINGS

The invention will be described in more detail below with reference to examples of embodiments shown in the drawings attached hereto, and in which:

FIG. 1 is a perspective view showing a first advantageous embodiment of a support device configured according to the teachings of the present invention; and

FIG. 2 is a perspective view showing a second advantageous embodiment of the support device configured according to the present invention.

### MODE FOR THE INVENTION

The examples of embodiments of the invention and further developments described below must be seen only as examples and should in no way be taken as limiting the scope of the patented claims. In the examples of embodiments that are described, the same reference numbers relate to the same type of part in the various Figs. For this reason, each part is not described in detail in all of the exemplary embodiments.

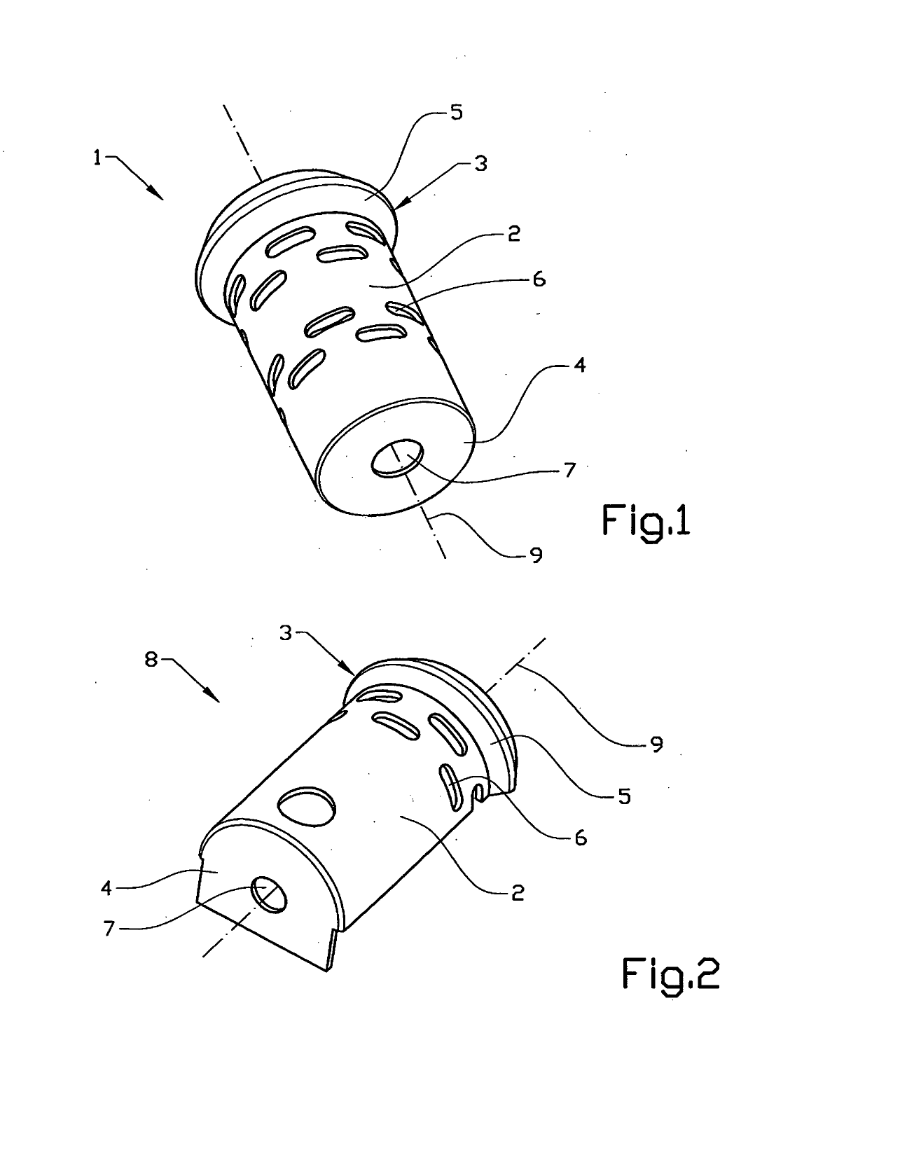

A support device configured according to the teachings of the invention can be designed as a tubular element taking the form of either a closed tube as shown in FIG. 1, or as a partially circular tube as shown in FIG. 2. FIG. 1 shows a first example of an embodiment of the support device 1 configured according to the teachings of the invention. The support device comprises (includes, but is not limited to) a circumferential surface 2, an edge section 3, a bottom section 4 and a fitting aperture 7. The transition between the circumferential surface 2 and the edge section 3 comprises a radius 5 adapted to suit the components that are to be fitted thereby. The circumferential surface exemplarily comprises a number of oval notches 6. The support device has a central axis 9 about which the support device is rotationally symmetrical. When the support device is designed as a closed, tubular element, it is advantageous for the support device to be completely circular, although a somewhat elliptical form is also feasible.

The support device 1 is adapted for fitting vehicle-specific components, in particular pipes, hoses and cables to a vehicle, and exemplarily, to the frame of a truck. These components may be air hoses, hydraulic hoses, cooling pipes or cabling, for example. Cabling typically consists of cables that are either loose or contained in a soft hose or in a corrugated plastic pipe. When a component is to be fastened to the support device, this is advantageously done by means of a cable tie, which is threaded through a notch 6 and then around the edge of the support device 3. The cable tie is tightened so that the component is drawn against the circumferential surface 2 of the support device. If a plurality of components is to be fastened alongside one another, one or more cable ties may be used.

The dimensions of the support device, for example thickness, length, radius of the circumferential surface and the like are suitably selected. In this regard, the support device is configured to fulfill the strength requirements placed thereupon. The length is determined, for example, by how many components are possible to fit side-by-side to the support device. The radius of the circumferential surface is determined, for example, by how the support device is to be mounted. If it is mounted by means of a bolt, there must be sufficient space in the support device for the socket that tightens the bolt.

The support device 1 is fastened to the frame of the vehicle with a bolt that is threaded through the fitting aperture 7 in the bottom section 4 of the support device so that the bottom section bears against the frame. The fitting aperture 7 is advantageously centered about the central axis 9 in the bottom section 4, but it is also possible to locate it eccentrically. It is also possible either to fasten the support device by riveting, or for the hole to have a threaded section that is adapted to receive a bolt. It is also possible for the bottom section to have a threaded projecting part, for example an integrally cast stud bolt, to which a nut can be fitted.

The component to be fitted to the support device is placed on the support device so that the longitudinal extent of the component runs transversely to the longitudinal extent of the support device. That is to say, the component is fitted approximately at right angles to the central axis of the support device. This is referred to herein as the direction of orientation of the component. In this exemplary embodiment, the longitudinal extent of the support device, that is to say the central axis of the support device, is at right angles to the bottom section 4.

The support device is made from a material suited to the purpose. The choice of material and the dimensioning may be determined by, among other things, strength requirements placed upon the device. A suitable material may be a plastic material or rubber material. When these materials are compression molded, the support device can instantaneously assume its final appearance so that no finishing treatment is required. This may be a cost-effective solution where the support device is mass-produced. Another suitable material is a metal. It is advantageous to proceed from a surface-treated sheet metal which is pre-punched with a number of notches 6 and which is then formed by known methods into a tubular support device having an edge section 3 and a bottom section 4 in which the fitting aperture 7 is located.

The shape of the notches 6 in the circumferential surface is adapted to the fitting devices used. When cable ties are used as fitting device, for example, the notches are therefore elongated in the direction of orientation of the support device so that the cable tie has a plane contact surface with the support device when it is threaded through the notch. It is also possible to have notches with a number of different shapes on one and the same support device in order to suit various fitting devices. In this example, there are multiple rows of notches 6, laterally and diametrically offset in relation to one another so that regardless of the orientation of the support device, there is always a notch 6 that is advantageously positioned in order to be able to fasten the component in question. In certain cases it may be advantageous also to provide the edge section 3 with similar notches.

The circumferential surface may advantageously be provided with grooves (not shown) in the fitting direction of the components. These grooves suitably have a radius which is matched to the components to be fitted. This may be advantageous, for example, where multiple components are fitted to the same support device so that the components are more easily held in place. The grooves are suitably located between the rows of notches.

The advantage in designing the support device with a circular circumferential surface is that it renders the support device entirely independent of how it is oriented when fitting. When conventional support devices are fitted, their orientation is dependent on the fitter fitting them. With a support device configured according to the invention, the orientation of the support device is therefore not dependent on the fitter.

FIG. 2 shows a first development of the support device configured according to the invention, here denoted by 8. The support device 8 is designed with a partially circular circumferential surface 2. This means that the support device 8 can be likened to an angular segment of the tubular support device 1 as described above. FIG. 2 shows a support device 8 in which the angular segment is 180 degrees. The angular segment is advantageously between 30 and 220 degrees. This support device also has a central axis 9 about which the circumferential surface is rotationally symmetrical. It is also possible to make the support device 8 somewhat elliptical.

The aim of this development or version is to simplify the fitting of vehicle-specific components where multiple components are to be fitted to the same support device 8. If more than two components are to be fitted to the same support device 8, it is advantageous to use at least two cable ties. In order to fasten the inner components, the cable tie may need to be threaded through two notches 6, firstly down through a notch 6 and then back up through another notch 6, as viewed from the circumferential surface 2, in order to hold the component in place. This is made easier if the support device 8 has a partially circular circumferential surface 2 since the fitter can more easily thread the cable tie through the notch 6. It is naturally also possible to thread each of the two cable ties through its own notch 6 and then around the edge 3 of the support device.

This support device 8 may be made of a plastic material, rubber material or a metal. When the support device is compression molded, the compression molding tool is inexpensive and easy to produce, which means that the unit price of the support device can be low. When the support device 8 is made of metal it is advantageous to proceed from a surface-treated sheet metal that is pre-punched with a number of notches 6 and is then formed by known method into a support device 8 having the desired form. An edge section 3 and a bottom section 4 in which the fitting aperture 7 is situated can be formed at the same time. The bottom section 4 may be bent outwards so that it is situated on the circumferential surface 2 side of the support device 8, or it may be bent inwards so that it is situated on the opposite side of the support device 8 to the circumferential surface 2. The bottom section 4 may also have an angle other than 90 degrees to the circumferential surface 2.

The invention must not be regarded as being limited to the examples of the several embodiments described herein, but a number of further variants and modifications are contemplated as being feasible, and without departing from the scope of the patent claims. It should also be appreciated that the support device can be used, for example, for fitting pipes, hoses and cabling in fixed installations where the components need to be fitted in different directions.

1. A support device for fastening articles such as pipes, hoses and cabling to a vehicle, said device comprising:
a support body, being at least partially substantially circular in shape, and having a convex circumferential surface oriented around an essentially linear longitudinal axis and a bottom section configured to fasten the support device to the vehicle.

2. The support device as recited in claim 1, wherein the bottom section is substantially perpendicular to the circumferential surface.

3. The support device as recited in claim 1, wherein the partially circular circumferential surface of the support device spans between thirty and two hundred and twenty degrees.

4. The support device as recited in claim 1, wherein the circumferential surface of the support device is circular.

5. The support device as recited in claim 1, wherein the circumferential surface of the support device includes at least one notch.

6. The support device as recited in claim 1, wherein at least one notch extends in a transverse direction relative to the longitudinal axis of the body of the support device.

7. The support device as recited in claim 1, wherein the circumferential surface of the body of the support device has at least one depression the is transversely oriented relative to the longitudinal axis of the body of the support device.

8. The support device as recited in claim 7, wherein said at least one depression has a radius configured to conform to an article to be secured to a vehicle by said support.

9. The support device as recited in claim 1, wherein the circumferential surface of the body of the support device has at least one elevation that is transversely oriented relative to the longitudinal axis of the body of the support device.

10. The support device as recited in claim 9, wherein said at least one depression has a radius configured to conform to an article to be secured to a vehicle by said support.

11. The support device as recited in claim 1, wherein said body of said support device is configured to establish a substantially conformance fit about at least one of pipes, hoses and cabling.

12. The support device as recited in claim 1, wherein said body of said support device is constructed of a metal, a rubber or a plastic material.

13. The support device as recited in claim 1, wherein said body of said support device is constructed from a punched and bent metal material.

14. The support device as recited in claim 1, wherein said body of said support device is constructed of a molded rubber material.

15. The support device as recited in claim 1, wherein said body of said support device is constructed of a compression molded plastic material.

16. The support device as recited in claim 1, wherein said body of said support device is constructed of a molded plastic material.

17. The support device as recited in claim 1, wherein said body of said support device is constructed of a compression molded plastic material.
